(19) United States
(12) Patent Application Publication
(10) Pub. No.: US 2025/0166079 A1
(43) Pub. Date: May 22, 2025

(54) SYSTEM AND METHOD FOR AUTOMATED RESPONSE TRACKING AND ZONING

(71) Applicant: AZTEK SECURITIES, LLC, Baton Rouge, LA (US)

(72) Inventors: Nitin Kamath, Baton Rouge, LA (US); Aparna Kamath, Baton Rouge, LA (US); Sachin Kamath, Prairieville, LA (US)

(21) Appl. No.: 18/415,994

(22) Filed: Jan. 18, 2024

Related U.S. Application Data
(63) Continuation of application No. 18/513,719, filed on Nov. 20, 2023.

(51) Int. Cl. G06Q 40/08; H04W 4/021

(52) U.S. Cl. CPC G06Q 40/08; H04W 4/021

(57) ABSTRACT

The present disclosure is directed to an automated system and method for providing automated response tracking and zoning. Preferred embodiments of the present invention are directed to generating and transmitting communications to users, tracking and mapping communication responses and automatically generating zones based on data received in conjunction with the communication responses.

### RELATED APPLICATIONS

This application is a continuation of U.S. patent application Ser. No. 18/513,719, filed Nov. 20, 2023, which is hereby incorporated by reference in its entirety.

### TECHNICAL FIELD

The present disclosure is directed to an automated system and method for providing automated response tracking and zoning. Preferred embodiments of the present invention are directed to generating and transmitting communications to users, tracking and mapping communication responses and automatically generating zones based on data received in conjunction with the communication responses.

### BACKGROUND

Multiple endeavors, whether governmental, commercial, community planning, or otherwise, generally require the zoning of geographic regions for their purposes. Whether it is planning the placement of emergency services, such as fire stations or police stations, or determining the best location for a new business, or even determining insurance rates for various policies, having detailed and actionable information is crucial.

In general, governmental, community or commercial entities may attempt to leverage surveys, census materials, or other information, in order to make these determinations. However, these can be difficult to conduct, hard to track, and hard to determine the accuracy or veracity of such data collection attempts. This can result in suboptimal results.

When dealing with these critical decisions, having suboptimal results can create disastrous situations. For instance, placing a fire station or police station in a suboptimal location can lead to harm or damage to both property and people. Even when it comes to understanding risk factors, having real actionable data can mean the difference between life and death.

Therefore, there is a need in the art for a system and method for an automated system and method for providing automated response tracking and zoning incorporating one or more system and methods for providing the generation of communications to those in a specific geographic region and tracking responses to those communications and automatically generating and updating zones based on the tracked responses.

### SUMMARY OF THE INVENTION

According to an embodiment of the present invention, a system for providing automated response tracking and zoning comprises: one or more hardware processors configured by machine readable instructions to: receive a request to generate a message, wherein the request to generate a message comprises recipient data and message information; identify a plurality of recipients, based at least in part on the recipient data; generate a message, based at least in part on the message information; transmit said message to said plurality of recipients; receive a set of responses from at least a portion of said plurality of recipients; and validate each response of said set of responses; identify, from content in each validated response in said set of responses, data points for generation of a zone map; and generate a zone map, based at least in part on the data points for generation of a zone map.

According to an embodiment of the present invention, the one or more hardware processors may be further configured by machine readable instructions to: generate an automated action response plan, based at least in part on said zone map; and provide said automated action response plan to a user.

According to an embodiment of the present invention, the one or more hardware processors may be further configured by machine readable instructions to: receive data related to the implementation of said automated action response plan; and update model data, based at least in part on the data related to the implementation of said automated action response plan.

According to an embodiment of the present invention, model data may be used by a machine learning module to generate automated action response plans and to generate zone maps.

According to an embodiment of the present invention, model data may be used by an artificial intelligence module to generate zone maps and automated action response plans.

According to an embodiment of the present invention, the one or more hardware processors may be further configured by machine readable instructions to: generate a second automated action response plan, based at least in part on updated model data; and provide said second automated action response plan to said user.

According to an embodiment of the present invention, the one or more hardware processors may be further configured by machine readable instructions to: generate, based at least in part on said zone map, insurance policy rates for each zone in said zone map.

According to an embodiment of the present invention, the one or more hardware processors may be further configured by machine readable instructions to: receive a set of updated responses; generate an updated zone map, based at least in part on said set of updated responses; and provide said updated zone map to a user.

According to an embodiment of the present invention, the one or more hardware processors may be further configured by machine readable instructions to: update insurance policy rates for one or more zones in said updated zone map.

According to an embodiment of the present invention, a computerized method for providing automated response tracking and zoning comprises: receiving, via a communication module, a request to generate a message, wherein the request to generate a message comprises recipient data and message information; identifying, via one or more processors, a plurality of recipients, based at least in part on the recipient data; generating, via one or more processors, a message, based at least in part on the message information; transmitting said message to said plurality of recipients; receiving a set of responses from at least a portion of said plurality of recipients; and validating, via one or more processors, each response of said set of responses; identifying, from content in each validated response in said set of responses, data points for generation of a zone map; and generating, via one or more processors, a zone map, based at least in part on the data points for generation of a zone map.

According to an embodiment of the present invention, the method may further comprise: generating an automated action response plan, based at least in part on said zone map; and providing said automated action response plan to a user.

According to an embodiment of the present invention, the method may further comprise: receiving data related to the implementation of said automated action response plan; and updating model data, based at least in part on the data related to the implementation of said automated action response plan.

According to an embodiment of the present invention, the method may further comprise: generating a second automated action response plan, based at least in part on updated model data; and providing said second automated action response plan to said user.

According to an embodiment of the present invention, the method may further comprise: generating, based at least in part on said zone map, insurance policy rates for each zone in said zone map; receiving a set of updated responses; generating an updated zone map, based at least in part on said set of updated responses; providing said updated zone map to a user; and updating insurance policy rates for one or more zones in said updated zone map.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a schematic illustration of an exemplary computing device, in accordance with at least some exemplary embodiments of the present invention;

FIG. 2 is a schematic illustration of an exemplary network, in accordance with at least some exemplary embodiments of the present invention;

FIG. 3 is an illustration of an exemplary method for providing automated response tracking and zoning, in accordance with an embodiment of the present invention;

FIG. 4 is an illustration of an exemplary method for providing automated response tracking and zoning, in accordance with an embodiment of the present invention;

FIG. 5a is an illustration of a graphical user interface for creating communications related to an exemplary method for providing automated response tracking and zoning, in accordance with an embodiment of the present invention;

FIG. 5b is an illustration of a graphical user interface for reviewing responses to communications related to an exemplary method for providing automated response tracking and zoning, in accordance with an embodiment of the present invention; and

FIG. 5c is an illustration of a response map related to an exemplary method for providing automated response tracking and zoning, in accordance with an embodiment of the present invention.

### DETAILED DESCRIPTION

According to one embodiment of the present invention, a system for automated response tracking and zoning may be comprised of a set of computer enabled modules that provide entities (which include but are not limited to regulatory and contractors) the ability to generate communications to a group of individuals or users based on certain criteria. The criteria may include, but is not limited to, phone number, location as identified in any appropriate location based service (LBS) means (such as GPS tracking, cellular triangulation or cell tower identification), information stored in a database, information provided to the system from a third-party source, or any combination thereof. One of ordinary skill in the art would appreciate that there are numerous types of criteria that could be used to identify a group of individuals or users, and embodiments of the present invention are contemplated for use with any such criteria.

Once generated, the communication is sent to the group of individuals or users via one or more communications systems. For instance, the system may be configured to send the communication to the mobile devices of the individuals or users. Other means of communication may include, but are not limited to, SMS messages, email, app based communications, social media platforms, or any combination thereof.

In certain embodiments of the present invention, the system tracks responses from each of the individuals or users. For instance, in preferred embodiments, the system is configured to use the communication systems of the individuals or users to identify and track responses, such as by identifying parameters or data received from the communication systems, such as phone number, device ID, email address, or other metadata or information received in conjunction with the response.

According to an embodiment of the present invention, the system may digitally collect and store data associated with the response. For instance, the system may be configured to store responses to specific inquires made in the communications. In certain embodiments, the responses may be updatable, allowing individuals or users to alter earlier responses to the communications. For instance, if a communication was sent out asking if users or individuals have a working fire alarm in their residence, and an individual initially answered no, but later had one installed, the system may be configured to allow the individual to update that response, which also may prompt an automated regeneration of zoning, based on that updated response.

According to an embodiment of the present invention, the system may be configured to automatically generate zones, based on the responses to the communications. For instance, in the example provided above related to the presence of a fire alarm, the system could be configured to create a map with geographic zones of users and individuals with fire alarms and without fire alarms. These maps containing geographic zones could be used for a variety of purposes, such as setting insurance rates, or to create areas to engage in actionable awareness campaigns in order to increase adoption of fire alarms. Other examples include using a map with geographic zones indicating locations where violent crimes have been committed, in order to identify the best location for an additional police station, police patrols, or even additional lights and/or cameras for deterrence. One of ordinary skill in the art would appreciate that there are numerous types of tracked communication responses that could be used to generate maps containing geographic zones, and embodiments of the present invention are contemplated for use with any appropriate communication responses, and zoning purposes.

Moreover, the system may be further configured to use previous communications and responses, and information provided to the system about results of zoning (e.g., placing of a police station in a particular zone resulted in a desired reduction in crime), in order to optimize and improve the performance of the automated zone creation performed by embodiments of the present invention. In order to do this, embodiments of the present invention may leverage artificial intelligence or machine learning techniques and systems, such as, but not limited to, machine learning models trained on various amounts of test and training data, neural networks (e.g., Artificial Neural Networks (ANN), Convolution Neural Networks (CNN), Recurrent Neural Networks (RNN)), deep learning models and deep-learning-based generative models (e.g., generative adversarial networks (GANs)). One of ordinary skill in the art would appreciate that there are numerous types of ML and AI systems that could be used for the purposes detailed herein, and embodiments of the present invention are contemplated for use with any such ML or AI system.

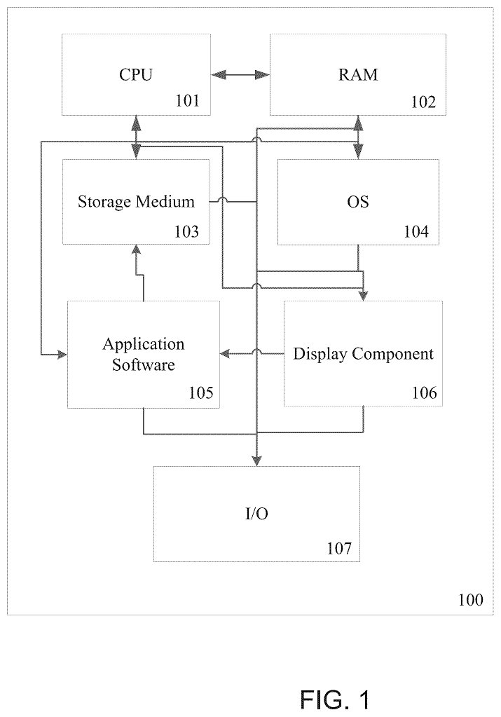

Turning now to FIG. 1, an illustrative representation of a computing device appropriate for use with embodiments of the system of the present disclosure is shown. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display clement (e.g., monitor, capacitive touchscreen) 106, and one or more input/output devices/means 107, including one or more communication interfaces (e.g., RS232, Ethernet, Wifi, Bluetooth, USB). Useful examples include, but are not limited to, personal computers, servers, tablet PCs, smartphones, or other computing devices. In preferred embodiments of the present invention, multiple computing devices can be operably linked to form a computer network in a manner as to distribute and share one or more resources, such as clustered computing devices and server banks/farms.

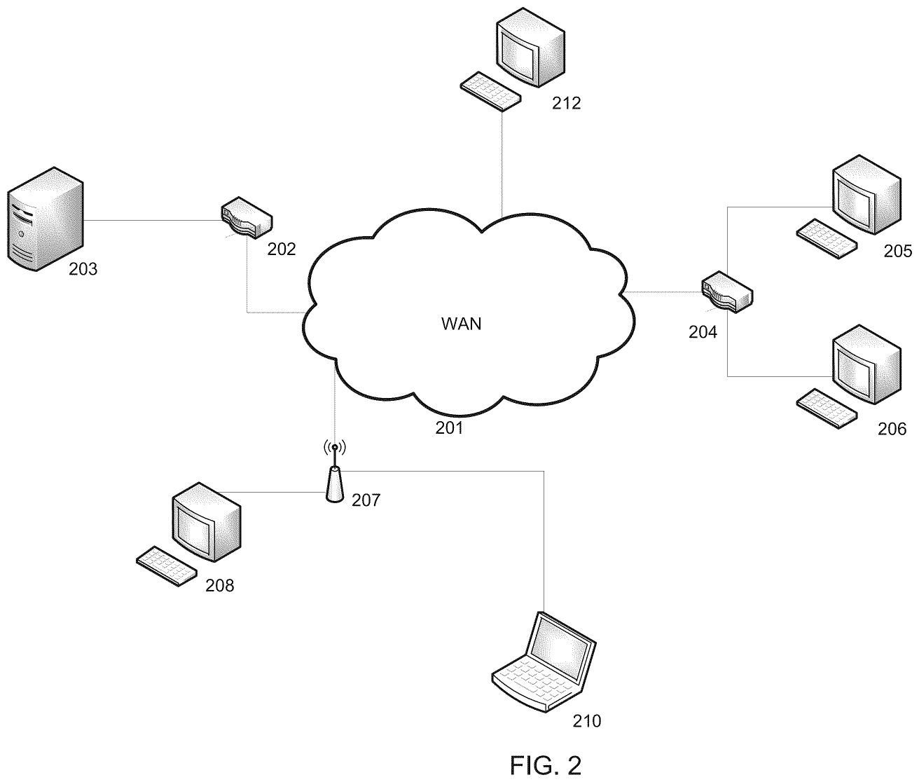

Various examples of such single-unit and multi-unit computer networks suitable for embodiments of the disclosure, their typical configuration and many standardized communication links are well known to one skilled in the art, as explained in more detail and illustrated by FIG. 2, which is discussed herein-below.

According to an exemplary embodiment of the present disclosure, data may be transferred to the system, stored by the system and/or transferred by the system to users of the system across local area networks (LANs) or wide area networks (WANs). In accordance with the previous embodiment, the system may be comprised of numerous servers, mining hardware, computing devices, or any combination thereof, communicatively connected across one or more LANs and/or WANs. One of ordinary skill in the art would appreciate that there are numerous manners in which the system could be configured and embodiments of the present disclosure are contemplated for use with any configuration.

Referring to FIG. 2, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, or iii) through a computing device 208, 210 connected to a wireless access point 207. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The exemplary disclosed system and method may be used in any suitable application for providing an automated method for providing automated response tracking and zoning. The exemplary disclosed system and method may for example be used in any application in which providing automated response tracking and zoning is useful in ensuring the tracking of various zones based on data points identified in the tracked responses.

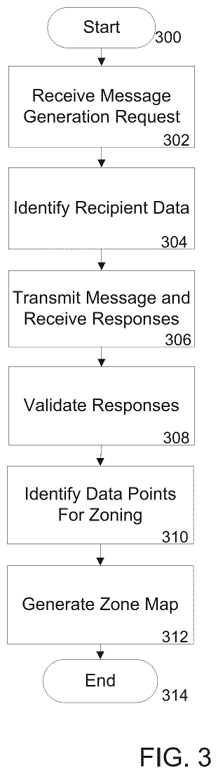

Turning now to FIG. 3, an exemplary method for providing automated response tracking and zoning, in accordance with an embodiment of the present invention, is shown. The process starts at 300 with the system being engaged to initiate a zoning campaign. At step 302, the system receives a message generation request. In certain embodiments of the present invention, a message generation request may include one or more questions to be asked to one or more users or individuals, as well as other information and data required to generate and transmit the message.

At step 304, the system identifies recipient data in the message generation request. In preferred embodiments, the message generation request may include data associated with identifying users or individuals to receive a generated message. This may, for instance, be in the form of a geographic region (e.g., via a map, via a zip code, via an area code, via a phone number prefix, via stored database information relating to a zone), from which addresses or other location-based information can be used to identify users or individuals to transmit the generated message to. In other embodiments, the system may be configured to identify the users or individuals to receive the generated message via other means, such as using an artificial intelligence or machine learning system using a large language model to review the one or more questions to be asked, and automatically generate a user and/or individual list to send the message to based on the one or more questions to be asked.

At step 306, the system transmits the message to the users and/or individuals identified in the previous step. At this point, the system will also begin receiving responses to the one or more questions contained in the message. This process may be continual, such that responses can be received over any period of time. In other embodiments, the process may have specific timing (e.g., responses must be received by a certain time/date).

Step 308 may be optional, but in certain preferred embodiments, at this point, the system validates the veracity of the responses. Verification or validation of responses may help provide more accurate generation of the zone mapping later. In accordance with embodiments of the present invention, verification and/or validation of responses can be accomplished via a variety of manners, including, but not limited to, confirming metadata contained in a response, requiring login to a system in order to provide a response, two factor authentication (2FA), geolocation/geo-fencing methods to ensure the individual or user is in the geographic region associated with potential zone generation, or any combination thereof. One of ordinary skill in the art would appreciate that there are numerous methods for validating or verifying a response, and embodiments of the present invention are contemplated for use with any appropriate means for validating or verifying responses. Further, in preferred embodiments, the system will only utilize verified or validated responses and ignore those that were not.

At step 310, the system uses data received in the responses to identify certain data points useable in the generation of one or more zone maps. One main data point would be the answers to the questions provided in the responses. However, the system may also further use other information contained in the responses as well, such as time of submission of a response, geolocation information, device type used to submit response, IP address, phone number, or any combination thereof. One of ordinary skill in the art would appreciate that there are numerous types of additional information that may be associated with an electronically submitted response, and embodiments of the present invention are contemplated for use with any appropriate type of additional information provided in a response.

At step 312, the system uses the zoning data points to generate one or more zone maps, creating zones related to the data points received in the responses. The system may then provide the one or more zone maps to a requesting user, and at that point, the process will terminate at step 314.

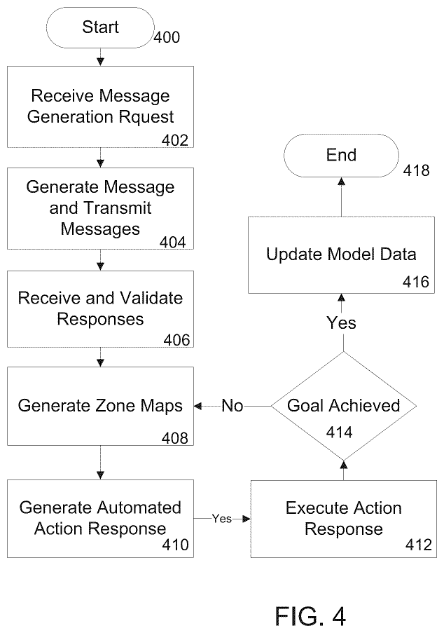

Turning now to FIG. 4, an illustration of an exemplary method for automated response tracking and zoning, in accordance with an embodiment of the present invention, is shown. The process starts at step 400 with the system being engaged to initiate a zoning campaign. At step 402, the system receives a message generation request, aimed at generating a message for delivery to a plurality of individuals and/or users. Similar in the exemplary method detailed in FIG. 3, the message generation request may include various data points and information required to generate a message and identify the individuals and/or users associated with the zoning campaign.

At step 404, similar to the method depicted in FIG. 3, the system generates and transmits the message to the plurality of users and/or individuals associated with the zoning campaign. At step 406, the system receives and validates the responses, ensuring accuracy and applicability of the responses in order to eliminate errant or irrelevant responses.

At step 408, the system uses the responses to generate zone maps, utilizing AI and/or ML means, supported by the data point contained in the responses. At step 410, utilizing the zone maps, the system generates an automated action response based at least in part on the generated zone maps. Automated action responses are suggestions for actions to be taken, based at leased in part on the responses, data points in the responses, the generated zone maps, or any combination thereof. Examples of automated action responses include, but are not limited to, proposing an information campaign for an identified zone, suggesting of a location for a facility (e.g., police station, fire station, retail location, security camera, lamppost, public park, school), generating insurance rate zones based on the zone maps, generating police patrol routes, generating plans for employee headcount needs (e.g., how many police officers needed, how many firefighters are needed), generating awareness campaigns for specific potential incidents in certain zones (e.g., information regarding the need for foam agent apparatus in a particular zone that would be susceptible to wildfires during a wildfire advisory). One of ordinary skill in the art would appreciate that there are numerous types of automated action responses that could be generated by the system, and embodiments of the present invention are contemplated for use with any appropriate automated action responses.

At step 412, the automated action response is implemented. At step 414, the system is provided updated information on the execution of the automated action response, generally related to the successfulness, or lack thereof, of the implementation at achieving the goal of the automated action response. Success could be measured in part by generating an additional message request and seeing how the responses have changed since the execution of the automated action response. If the implementation of the automated action response was successful, the system can update its model data at step 416, and the process will terminate at step 418. If the implementation of the automated action response was unsuccessful, the system may update its model data and go back to step 408 to regenerate zone maps in accordance with its updated models.

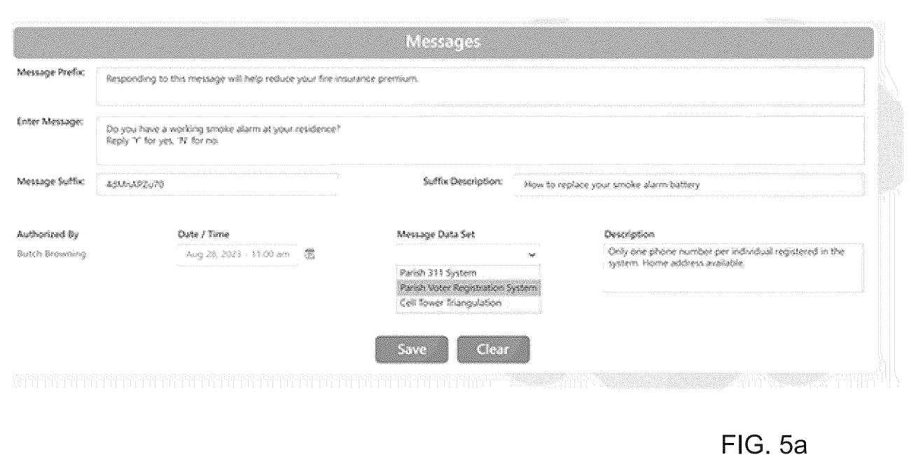

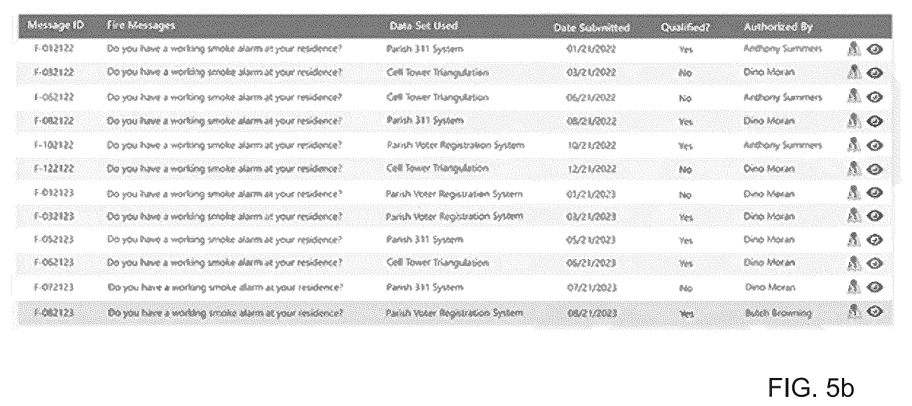

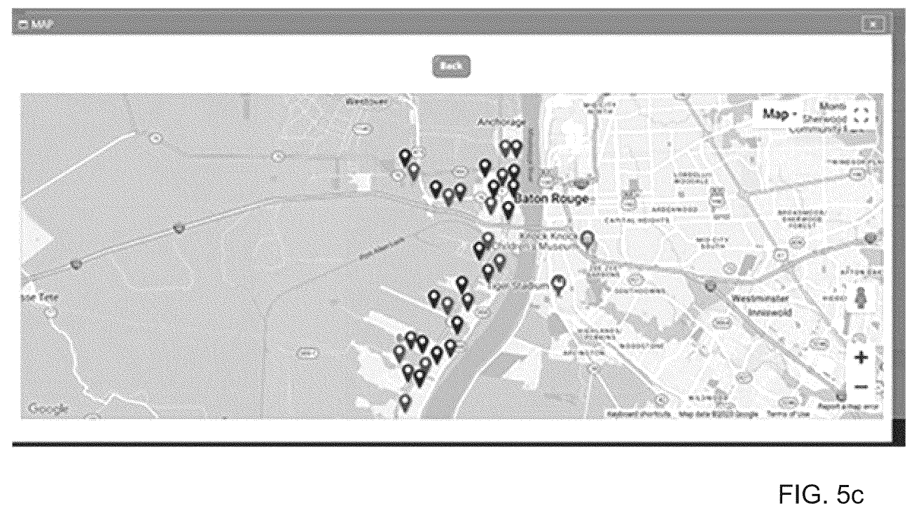

Turning now to FIG. 5, an exemplary embodiment of a graphical user interface (GUI) is shown for generating a message. Various data points and questions can be asked for and in certain embodiments, a purpose for the request of the information may be provided. FIG. 6 shows an exemplary embodiment of a GUI depicting a collection of responses to the sent message. Finally, FIG. 7 shows an exemplary embodiment of a GUI depicting the location of the responses received in response to the sent message. In a preferred embodiment of the present invention, it is from these responses that the zone maps would be generated.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

1. A system for providing automated response tracking and zoning, the system comprising:
one or more hardware processors configured by machine readable instructions to:
identify a geographic area for emergency services zoning;
generate a message in response to a zoning request, the zoning request comprises message information, wherein the message information includes a request for emergency services information;
identify a plurality of recipients, based at least in part on the geographic area;
transmit said message to said plurality of recipients using one or more communication systems;
receive responses from at least a portion of said plurality of recipients in real time;
validate each response received from said portion of said plurality of recipients as the responses are received, wherein each response is validated at least by verifying a geolocation of the response is within the geographic area;
identify, from content in each validated response, data points for generation of a zone map of the geographical area, the zone map having a plurality of emergency service zones;
generate the zone map, based at least in part on the data points for generation of the zone map;
provide access, over a network, to said portion of said plurality of recipients to update the response received from said portion of said plurality of recipients in real time;
receive updated responses from at least a portion of said recipients;
validate each updated response, wherein each updated response is validated at least by verifying a geolocation of the update to the response is within the geographic area;
identify, from content in each validated updated response, an update to the zone map, the update to the zone map including an update to at least one of the plurality of emergency service zones;
generate an updated zone map, based at least in part on the update to the zone map;
display one or more of the responses or updated responses on a graphical user interface of the updated zone map based on the verified geolocation of the response or update to the response; and
provide said updated zone map to a user.

2. The system of claim 1, wherein said one or more hardware processors are further configured by machine readable instructions to:
generate an automated action response plan, based at least in part on said zone map; and
provide said automated action response plan to a user.

3. The system of claim 2, wherein said one or more hardware processors are further configured by machine readable instructions to:
receive data related to the implementation of said automated action response plan; and
update model data, based at least in part on the data related to the implementation of said automated action response plan.

4. The system of claim 3, wherein the model data is used by a machine learning module to generate automated action response plans.

5. The system of claim 3, wherein the model data is used by a machine learning module to generate zone maps.

6. The system of claim 3, wherein the model data is used by an artificial intelligence module to generate zone maps.

7. The system of claim 3, wherein the model data is used by an artificial intelligence module to generate automated action response plans.

8. The system of claim 3, wherein said one or more hardware processors are further configured by machine readable instructions to:
generate a second automated action response plan, based at least in part on updated model data; and
provide said second automated action response plan to said user.

9. The system of claim 1, wherein said one or more hardware processors are further configured by machine readable instructions to:
generate, based at least in part on said zone map, an insurance policy rates adjustment for each zone in said zone map.

10. (canceled)

11. The system of claim 9, wherein said one or more hardware processors are further configured by machine readable instructions to:
update the insurance policy rates adjustment for one or more zones in said updated zone map.

12. A computerized method for providing automated response tracking and zoning, the method comprising:
identifying a geographic area for emergency services zoning;
generating a message in response to a zoning request, the zoning request comprises message information, wherein the message information includes a request for emergency services information;
identifying, via one or more processors, a plurality of recipients, based at least in part on the geographic area;
transmitting said message to said plurality of recipients using one or more communication systems;
receiving responses from at least a portion of said plurality of recipients in real time;
validating, via one or more processors, each response received from said portion of said plurality of recipients as the responses are received, wherein validating each response includes verifying a geolocation of the response is within the geographic area;
identifying, from content in each validated response, data points for generation of a zone map of the geographic area, the zone map having a plurality of emergency service zones;
generating, via one or more processors, the zone map, based at least in part on the data points for generation of a zone map;
providing access, over a network, to said portion of said plurality of recipients to update the response received from said portion of said plurality of recipients in real time;
validating, via one or more processors, each updated response, wherein validating each updated response includes verifying a geolocation of the update to the response is within the geographic area;
identifying, from content in each validated updated response, an update to the zone map, the update to the zone map including an update to at least one of the plurality of emergency service zones;
generating an updated zone map, based at least in part on the update to the zone map;
display one or more of the responses or updated responses on a graphical user interface of the updated zone map based on the verified geolocation of the response; and
providing said updated zone map to a user.

13. The method of claim 12, further comprising:
generating an automated action response plan, based at least in part on said zone map; and
providing said automated action response plan to a user.

14. The method of claim 13, further comprising:
receiving data related to the implementation of said automated action response plan; and
updating model data, based at least in part on the data related to the implementation of said automated action response plan.

15. The method of claim 14, wherein the model data is used by a machine learning module to generate automated action response plans.

16. The method of claim 14, wherein the model data is used by a machine learning module to generate zone maps.

17. The method of claim 14, wherein the model data is used by an artificial intelligence module to generate zone maps.

18. The method of claim 14, wherein the model data is used by an artificial intelligence module to generate automated action response plans.

19. The method of claim 14, further comprising:
generating a second automated action response plan, based at least in part on updated model data; and
providing said second automated action response plan to said user.

20. The method of claim 12, further comprising:
generating, based at least in part on said zone map, an insurance policy rate adjustment for each zone in said zone map; and
updating the insurance policy rates adjustment for one or more zones in said updated zone map.

21. A system for providing automated response tracking and zoning, the system comprising:
one or more hardware processors configured by machine readable instructions to:
identify a geographic area for emergency services zoning;
generate a message in response to a zoning request, the zoning request comprises message information, wherein the message information includes a request for emergency services information;
identify a plurality of recipients, based at least in part on the geographic area;
transmit said message to said plurality of recipients using one or more communication systems;
receive responses from at least a portion of said plurality of recipients in real time;
validate each response received from said portion of said plurality of recipients as the responses are received, wherein each response is validated at least by verifying a geolocation of the response is within the geographic area;
identify, from content in each validated response, data points for generation of a zone map of the geographical area, the zone map having a plurality of emergency service zones;
generate the zone map, based at least in part on the data points for generation of the zone map provide access, over a network, to said portion of said plurality of recipients to update the response received from said portion of said plurality of recipients in real time;
receive updated responses from at least a portion of said recipients;
validate each updated response, wherein each updated response is validated at least by verifying a geolocation of the update to the response is within the geographic area;
identify, from content in each validated updated response, an update to the zone map, the update to the zone map including an update to at least one of the plurality of emergency service zones;
generate an updated zone map, based at least in part on the update to the zone map;
display one or more of the responses or updated responses on a graphical user interface of the updated zone map based on the verified geolocation of the response or update to the response; and
provide said updated zone map to a user;
determine a risk associated with each of the plurality of emergency service zones in the updated zone map;
generate an insurance policy rate for each of the plurality of emergency service zones, wherein the insurance policy rate is based on the determined risk;
store one or more of the responses, the updated responses, the zone map, or the updated zone map on a database associated with the geographic zone; and
retrieve previously stored responses, updated responses, zone maps, or updated zone maps from the database associated with the geographic zone;
wherein the update to the zone map is generated using an artificial intelligence module trained at least in part based on the previously stored responses, updated responses, zone maps, or updated zone maps.
